(19) United States
(12) Patent Application Publication
(10) Pub. No.: US 2017/0024531 A1
(43) Pub. Date: Jan. 26, 2017

(54) SYSTEMS AND METHODS FOR NEAR-REAL OR REAL-TIME CONTACT TRACING

(71) Applicant: RADICALOGIC TECHNOLOGIES, INC. DBA RL SOLUTIONS, Toronto (CA)

(72) Inventor: Sanjay MALAVIYA, Mississauga (CA)

(21) Appl. No.: 15/217,372

(22) Filed: Jul. 22, 2016

Related U.S. Application Data
(60) Provisional application No. 62/195,345, filed on Jul. 22, 2015.

(51) Int. Cl. G06F 19/00

(52) U.S. Cl. CPC G06F 19/3406; G06F 19/3431; G06F 19/325

(57) ABSTRACT

A healthcare information system for providing near-real or real-time contact tracing is provided comprising: a position data receiver unit configured to receive position data related to one or more entities associated with a healthcare facility; a contextual profile management unit configured to utilize received position data to generate, maintain or update one or more contextual profiles, each of the one or more contextual profiles corresponding to each of the one or more entities. Devices, systems and methods are provided related to the use of near-real or real-time contact tracing in applications including infection control, developing infection pathways, among others.

### CROSS REFERENCE TO RELATED APPLICATIONS

This application claims all benefit to, including priority of, U.S. Provisional Application No. 62/195,345, filed Jul. 22, 2015, entitled “SYSTEMS AND METHODS FOR NEAR-REAL OR REAL-TIME CONTACT TRACING”, incorporated herein by reference.

### FIELD

The present disclosure generally relates to the field of electronic healthcare, and more particularly to healthcare risk management.

### INTRODUCTION

A healthcare organization or facility may use healthcare systems for data entry to input and record health related data for healthcare risk management.

### SUMMARY

In accordance with an aspect, there is provided a computer-implemented method, the method comprising: receiving or continuously monitoring electronic position information associated with one or more entities (e.g. individuals, objects) within a healthcare facility during a duration of time, the electronic position information obtained through wireless signal triangulation or a GPS receiver of one or more client computing devices, each client computing device corresponding to one of the one or more individuals and acting in concert with a computational backend server residing in a healthcare data center; transforming, by the computational backend server, the electronic position information by appending one or more time coded contextual metadata tags to the electronic position information to generate contextualized electronic position information, the one or more contextual metadata tags appended when one or more electronic trigger conditions are satisfied; generating or updating one or more contextual digital profiles, each of the one or more contextual digital profiles corresponding to one of the one or more individuals with the contextualized electronic position information, each of the one or more contextual digital profiles including at least a computationally approximated probabilistic risk level that is updated when the one or more contextual digital profiles are updated or generated; and aggregating, by the computational backend server, the contextualized electronic position information with profile information stored in the contextual profile to generate at least one electronic map structure storing, as location points, current locations of the one or more individuals and associating, with each of the location points, the approximated probabilistic risk level for the corresponding individual; and generating a visual or an audible notification on a computing interface linked to the computational backend server if the approximated probabilistic risk level of any individual is greater than a predefined threshold.

In accordance with another aspect, the method further comprises: generating a visualization of the at least one electronic map structure; and updating, in real-time, the visualization as the one or more contextual digital profiles are updated or generated.

In accordance with another aspect, the computational backend server is adapted for generating electronic task routing signals for a healthcare task scheduling system and the method further comprises: receiving signals representative of the location of a healthcare practitioner and a duration of availability; superimposing a facility map and the at least one generated electronic map structure storing the current locations of the one or more individuals as nodes, wherein the approximated probabilistic risk level for each individual is re-weighted based at least on distance from the location of the healthcare practitioner, the superimposing generating an initial practitioner location-contextualized electronic map structure.

In accordance with another aspect, the method further comprises: generating an electronic map visualization of the initial practitioner location-contextualized electronic map structure wherein the re-weighted approximated probabilistic risk levels corresponding to each node are continuously monitored and a visual representation of the re-weighted approximated probabilistic risk level of each node is automatically resized or recolored based on the magnitude of the re-weighted approximated probabilistic risk level of the node.

In accordance with another aspect, the method further comprises: generating an electronic prioritized list, based on the initial practitioner location-contextualized electronic map structure, providing an ordered list of nodes ranked in accordance to the re-weighted approximated probabilistic risk level of the node.

In accordance with another aspect, the method further comprises updating the electronic prioritized list responsive to updated or generated contextual digital profiles.

In accordance with another aspect, the method further comprises using the initial practitioner location-contextualized electronic map structure as an initial state, recursively generating candidate pathways starting from the location of the healthcare practitioner and visiting a subset or all of the nodes as available during the duration of availability, wherein each of the candidate pathways has a cumulative treatment score based on the approximated probabilistic risk level associated with each node visited and each node visited is stored as an electronic waypoint in an ordered list of electronic waypoints; selecting a single candidate pathway having a highest cumulative treatment score; and generating, in accordance with the selected candidate pathway and the ordered list of electronic waypoints, one or more routing instructions for transmission to a client computing device associated with the healthcare practitioner, the one or more routing instructions configured for automatically populating an electronic scheduler on the client computing device such that the healthcare practitioner is instructed to visit each of the electronic waypoints in the selected candidate pathway.

In accordance with another aspect, the recursively generating of the candidate pathways further includes re-weighting each of the approximated probabilistic risk levels for neighboring nodes to a current node being traversed using the distance between the current node being traversed and the neighboring nodes.

In accordance with another aspect, the one or more routing instructions provides at least the location of the individual associated with each electronic waypoint, an estimated duration of therapeutic treatment, and directions to the next electronic waypoint in the ordered list of electronic waypoints.

In accordance with another aspect, the computationally approximated probabilistic risk level includes infection control information, the infection control information including at least a prevalence of transmission, one or more identified transmission vectors, and a severity of infection; and the generation or updating of the one or more contextual digital profiles further comprises identifying one or more estimated radii of transmission based on the prevalence of transmission, the one or more identified transmission vectors, and the severity of infection of one or more infected individuals, and increasing the approximated probabilistic risk level for other individuals that were in proximity with the one or more infected individuals as determined by the estimated radii of transmission and the time coded contextual metadata tags.

In accordance with another aspect, a healthcare information system for near-real or real-time contact tracing is provided, comprising: a position data receiver unit configured to receive position data related to one or more entities associated with a healthcare facility; a contextual profile management unit configured to utilize received position data to generate, maintain or update one or more contextual profiles, each of the one or more contextual profiles corresponding to each of the one or more entities; a rules engine configured to apply one or more logical rules, the one or more logical rules being applied to one or more contextual profiles to determine whether conditions for a trigger have been satisfied; a user interface unit configured to, upon determining that conditions for the trigger have been satisfied by the rules engine, generate interface data for provisioning to one or more interface components and to provide one or more notifications to a selected subset of the one or more entities through the one or more user interface components.

In accordance with another aspect, the healthcare information system is configured for operation with one or more access terminals over a network, each access terminal being associated with a corresponding one of the one or more user interface components associated with one or more computing devices.

In accordance with another aspect, there is provided a device for near-real or real-time contact tracing, comprising: a position data receiver unit configured to receive position data related to one or more entities associated with a healthcare facility; a contextual profile management unit configured to utilize received position data to generate, maintain or update one or more contextual profiles, each of the one or more contextual profiles corresponding to each of the one or more entities; a rules engine configured to apply one or more logical rules, the one or more logical rules being applied to one or more contextual profiles to determine whether conditions for a trigger have been satisfied; a user interface unit configured to, upon determining that conditions for the trigger have been satisfied by the rules engine, provide one or more notifications to a selected subset of the one or more entities through one or more user interface components.

In accordance with another aspect, the device is configured for operation with one or more access terminals over a network, each access terminal being associated with a corresponding one of the one or more user interface components associated with one or more computing devices.

In accordance with another aspect, there is provided a method of maintaining a contextual profile for near-real or real-time contact tracing, the method comprising: monitoring position information associated with an entity during a period of time; providing the position information to a contextual profile management unit configured to maintain and/or update contextual profiles associated with the entity; aggregating the position information with profile information stored in the contextual profile; periodically applying one or more logical rules in relation to the contextual profile associated with the entity to determine a risk level associated with the contextual profile; generating a visual or an audible notification if the risk level is greater than a predefined threshold.

In accordance with another aspect, there is provided a method for generating an electronic pathway representing a physical pathway in a healthcare organization for infection control using a system configured for near-real or real-time contact tracing, the method comprising: generating one or more electronic pathways based on position information associated with one or more entities during a period of time; identifying a potential infection using at least a probabilistic analysis of received profile information stored in one or more electronic contextual profiles; identifying one or more infected entities that have an infection probability greater than a predefined threshold; identifying one or more electronic pathways utilized by the one or more infected entities during a period of potential infection and setting a plurality of position nodes indicating that a plurality of positions are associated with infection; and generating a notification indicating that one or more electronic pathways are no longer safe for general use.

In accordance with another aspect, there is provided a method for controlling infection in a facility using a system configured for near-real or real-time contact tracing, the method comprising: providing information to the system indicating that an entity having probable infectious disease characteristics has been admitted; determining location characteristics of the entity that is mapped to locations in a healthcare organization; updating the contextual profile of the entity to indicate that the entity has a probability of being infected; periodically updating the contextual profile of the entity to update the probability that the entity is infected; and upon the probability that the entity is infected exceeding a predefined probability, causing one or more spaces in the facility to be marked as potentially infected based on the determined location characteristics.

In various further aspects, the disclosure provides corresponding systems and devices, and logic structures such as machine-executable coded instruction sets for implementing such systems, devices, and methods.

In this respect, before explaining at least one embodiment in detail, it is to be understood that the disclosure is not limited in its application to the details of construction and to the arrangements of the components set forth in the following description or illustrated in the drawings. Aspects described in this specification are capable of other embodiments and of being practiced and carried out in various ways. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a high-level block schematic of a system for generating a contextual profile in the context of a healthcare environment, according to some embodiments.

FIG. 2 is a schematic block diagram of a system for generating a contextual profile in the context of a healthcare environment, including various utilities that may be used in the implementation of the system, according to some embodiments.

FIG. 3 is a sample workflow diagram of a process for maintaining a contextual profile, according to some embodiments.

FIG. 4 is a sample workflow diagram of a process for conducting infection pathway analysis using at least information provided in the contextual profile, according to some embodiments.

FIG. 5 is a sample workflow diagram of a process for infection control using at least information provided in the contextual profile, according to some embodiments.

FIG. 6 is a schematic diagram of computing device, exemplary of an embodiment that may be particularly configured to interface with a healthcare risk management system.

### DETAILED DESCRIPTION

In an aspect, embodiments described herein may provide healthcare risk management systems, devices and processes that may effectively track or map infection, adverse incidents, and entities for efficient risk prediction, processing and management, including infection control, for example, by receiving, processing and aggregating position and time data points related to healthcare organizations to dynamically generate mapping data structures with multiple dimensions representative of the aggregated position and time data points. Contextual profiles associated with various entities related to the healthcare organization may also be generated using received data including the position and time data points. The contextual profiles may be used to generate or modify the dynamically generated mapping data structures to provide additional layers of data elated to healthcare organizations. Example embodiments of methods, systems, and apparatuses for dynamic contact tracing by the dynamic mapping data structure are described through reference to the drawings.

The healthcare risk management system may be configured to receive the location information and transform the location information using stored contextual data and/or generated healthcare predictions. The location information, for example, may be transformed and/or contextualized such that the information may be utilized for improved service delivery, service efficiency, patient flow, risk identification, and/or line tracing, among others.

In some embodiments, a computer-based healthcare management system is configured to generate one or more visual representations and/or interfaces whereby the contextualized location information is used, for example to dynamically relocated textual and/or graphical information, to automatically prioritize and/or sequence actions of an individual (such as a practitioner) based on the presence of one or more identified and/or determined conditions.

Some embodiments of the healthcare management system are configured specifically for providing an automated probabilistic infection tracking system. The automated probabilistic infection tracking system is configured to utilize healthcare scheduling data (e.g., operating room schedules, expected rounds, ward assignments) alongside location information and stored healthcare information system such that is used to contextualize location information such that the location is more readily consumed by healthcare information systems in determining, for example, routing instructions for providing to a practitioner, visualizations indicative of prioritized treatment tasks, visual notifications or audio notifications, among others.

The following discussion provides many example embodiments of the inventive subject matter. Although each embodiment represents a single combination of inventive elements, the inventive subject matter is considered to include all possible combinations of the disclosed elements.

As a specific example of context-aware applications, the system could be configured to identify patients for healthcare professional to visit when the healthcare professional is in a particular room or location, the patients identified and prioritized based on factors such as medical status, recent proximity to infected individual, etc. The factors for prioritization in this example can be tailored based, for example, on disease type, transmission methods, etc.

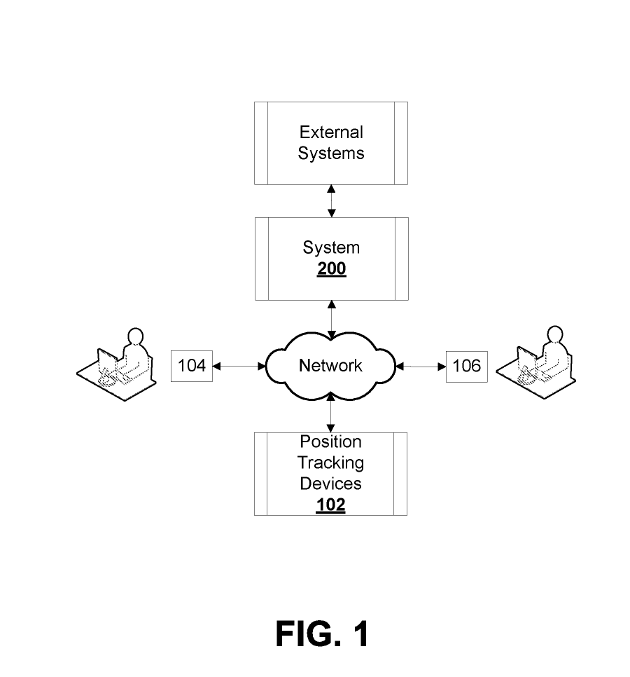

FIG. 1 shows a high-level block schematic of a system for generating a contextual profile in the context of a healthcare environment, according to some embodiments. The contextual profile may be used to generate or modify dynamic mapping data structures to provide additional layers of data representative of various features for the healthcare organizations.

The system may be utilized, for example, to generate a 2D or 3D map structure based on the correlated data and contextual profiles. The system uses the generated map structure to create a visualization of the map structure for display as part of an interface. The system can generate and display overlays for the visualization. The system may be able to generate the 2D or 3D map structure, for example, even in the absence of a known map. In certain situations, a known map may be otherwise confusing (having irrelevant details), not up to date (e.g., made at the time of construction, does not include movement of equipment, addition of new wings, repurposing of various sections), and might not be contextually relevant to healthcare outcomes, etc. In certain situations, a known map is not available. For example, in relation to facilities in the developing world or older healthcare facilities system might not have access to a known map of the facility. The system can also generate a 4D map structure over a time period so that the 2D or 3D map data is linked to time as a fourth dimension.

In some aspects, the system 200 is configured to operate in the context of a healthcare incident management (HIM) system used for healthcare risk management. The system 200 may, in some embodiments, be provided as part of an HIM system, where the HIM system is coupled to (e.g., through a network) a set of endpoints, such as workstations or access terminals, through one or more user interface components 104 and/or administrative interface components 106. These user interface components 104 may permit for access and/or modification of a contextual profile. The generated map structure may utilize information obtained in the contextual profile to refine and/or associate information associated with the generated the map structure from the healthcare incident management system. For example, a more accurate or more contextually appropriate map may be generated where the dataset is constrained only to specific geospatial points associated with particular contextual profiles (e.g., only during emergency situations, only nurses, etc.). The map structure can also have a time component to identify data for a relevant time period.

The system 200 is configured to dynamically generate and update or modify mapping data structures representative of multiple dimensions of data points (e.g. position, time, identifiers, descriptors, fields). The dynamic mapping data structures may represent a map health care organization that may provide real-time or near-real-time data relating to various aspects of the health care organization, including movement of individuals and equipment. The dynamic mapping data structures may provide an accurate and real time representation of key data points by aggregating multiple disparate data sets into comment data structures for efficient memory usage. The system 200 is configured to connect with user interface components 104 for efficient data exchange. The dynamic mapping data structures may accurately reflect time and position data for individuals and equipment for location and tracing services, along with infection control and risk mitigation service, for example.

The dynamic mapping data structures provides for improved map and data processing as the common data structure efficiently represents aggregated data points for further processing and transformation depending on the desired end service. The dynamic mapping data structures provide improved mapping techniques through real-time aggregation of various position data points received continuously from various location tracking devices, for example. The system 200 is configured to receive a static map of a health care organization as one example type of input data and use the static map in combination with the aggregated positional data points to generate the dynamic mapping data structures representing aggregated real-time or near real-time data points. In other example embodiments, the system 200 may not have access to a static map of a health care organization.

The system 200 may be provided in the form of backend networked devices that may be provided on-location at a healthcare environment, or off-location at an external location that is remotely coupled to the healthcare environment, or a combination thereof linked by a system interface. For example, the networked devices may include computational backend servers residing in a healthcare data center (or, in some embodiments, as distributed networked computing resources that reside in a cloud-type infrastructure) that act in concert with one or more client computing devices.

The client computing devices may track, for example, the electronic position information of one or more individuals (e.g., patients) within a healthcare facility using various location tracking techniques, such as operating room schedules, facility room check in/check out systems, wireless signal triangulation or a GPS receiver on the client computing device, beacons, received signal strength processing techniques, among others. The client computing devices may include pendants, trackers, smart phones/tablets (or mobile applications residing in memory or hardware thereon), among others.

The healthcare environment may include one or more facilities, such as hospitals, clinics, rehabilitation centers, psychiatric care facilities, hospices, birthing centers, geriatric centers, long term care facilities, etc. There may be various individuals present at the facilities, various objects present, such as consumable items, machinery, diagnostic equipment, medical devices, medical appliances, etc.

The generated contextual profile represents real world/tangible positions/locations/movements within a healthcare organization. For example, a contextual profile may contain information associated with individuals, objects, equipment, facilities (“entities”) that is based at least on information gathered regarding the movement, position, orientation, and/or interaction thereof of individuals and/or objects in the context of the facilities. Contextual profiles may be associated with different types of entities, for example, a contextual profile may be associated with an individual patient or practitioner, a facility, a medical device, etc. There may be a temporal aspect to the contextual profile; for example, the contextual profile may indicate movement at particular times of the day, during emergency situations, during periods of high infection activity, etc. Movement may be provided (e.g., received, determined) through movement data that corresponds to various time points and/or time segments. For example, movement may be tracked in the form of coordinates that are related to specific instances of time, or accelerometer information that is related to specific segments of time, or various combinations thereof. These combinations of movements and time may be grouped into various movement events (e.g., the patient has left her hospital bed).

The system 200 may be configured to incorporate information received from one or more position tracking devices 102, which may include inputs of information provided in various forms, such as GPS coordinates, cellular signal strength, accelerometer readings, gyroscope readings, wireless received signal strength, the use of location-based services, triangulation readings, Subscriber Identity Module (SIM) based readings (e.g., round-trip readings), crowdsourced data (e.g., WiFi based indoor positioning), LTE functionality (e.g., Enhanced Cell ID, Observed Time Difference of Arrival), manually input information, survey information (e.g., post-operative surveys), among others.

Other position information may include, for example, facility access information (e.g., a practitioner, upon entering a secured lab, is required to use a pass-card to verify and/or gain access to the secured lab), check-in beacons (e.g., a practitioner, upon entering an operating room, is required to use a computing device to “check-in”). Accordingly, devices 102 may have sensors such as gyroscopes, magnetometers, near-field communications (NFC) chips, cameras, bar-code readers, proximity sensors, accelerometers, WiFi, global GPS, compasses, temperature sensors, humidity sensors, fingerprint readers, etc.

Devices 102 may also have various electronic components, such as processors, input interfaces (e.g., keyboards, touch screens), output interfaces (e.g., display screens), microphones, speakers, input/output ports (e.g., a 3.5 mm headphone jack), etc. The electronic position information is monitored over a period of time. In some embodiments, the system actively tracks the electronic position information, and in other embodiments, the system receives the electronic position information). As noted, the position and time data is used by system to compute a map structure.

The devices 102, for example, may act in concert with the computational backend server residing in a healthcare data center such that information is transmitted and/or communicated synchronously, asynchronously, in batch, on demand, in a push or a pull topology, among others.

In some embodiments, devices 102 may also be configured to receive information from one or more externally located sensor. For example, the devices 102 may also be configured to receive information from an external pulse oximeter, a dialysis machine, a specially configured wheelchair, a hospital bed, etc. The electronic position information may be transformed by system 200 (e.g., by a computational backend server), for example, by appending one or more time coded contextual metadata tags to the electronic position information to generate contextualized electronic position information. For example, the time codes may indicate, based on a calibrated time clock synchronized independent of location tracking devices 102, when an object such as an individual was in a particular location. The one or more contextual metadata tags may be appended, for example, when one or more electronic trigger conditions are satisfied. These trigger conditions may include, for example, the satisfaction of a stored rule identified by a rules engine 214, a specific healthcare risk identified by risk identification subsystem 218, a tracked event leading to a potential adverse outcome or risk 206, a tracked infection as monitored by infection tracking engine 222, among others.

The contextual profile may be generated in real-time or near real-time, and may be updated as information is received and/or processed. The contextual profile may be used in supporting and/or conducting various tasks and/or analyses, such as hygiene/infection control (e.g., hand washing, infectious disease management), patient/practitioner routing, map generation, risk analyses (e.g., tracking hospital acquired diseases), predictive modelling, root cause analysis, hot spot identification, safety monitoring (e.g., access to sharp objects, harmful pharmaceutical drugs, exposure to allergens), regulatory/insurance reporting, etc. In some embodiments, the contextual profile stores in data storage 250 a set of data points having associated geo-spatial information (e.g., x, y, and z coordinates, among other coordinate systems), such that for a particular individual, context based content can be served (for example with current location derived via GPS, RFID, geolocation technology, or the user specifying their location).

The contextual profile may be stored, for example, in the form of a contextual digital profile wherein the digital profile includes at least a computationally approximated probabilistic risk level that is updated when the one or more contextual digital profiles are updated or generated. This risk level may be determined, for example, based on machine-learned and/or tracked event data associated with a propensity to create risk, and may be weighted based on risk severity (e.g., of an adverse health outcome).

For example, in the context of infection control, the contextual profile may be configured for receiving information based on the tracked movements of individuals or objects to dynamically establish a spatial map, the spatial map being used to, among other uses, track historical movements and real-time movements. The spatial map may be an example of a dynamic mapping data structure. The spatial map may represent multiple dimensions of data points (e.g. two dimensions, three dimensions, four dimensions, N dimensions), such as position and time, for example. Such a spatial map may be used to track various aspects related to the likelihood of diseases being spread, as people who are walking around having being associated with various diseases may be spreading such diseases through contact with others.

Contact with others may be analyzed based on various metrics, for example, contact for a time threshold may be associated with an increased likelihood of disease spreading. Information stored on contextual profiles may be used to, for example, develop a heat map of spreading disease in real-time which may be overlaid on top of spatial maps, etc. Various types of analyses can be performed using other disparate sets of data, such as the attributes of the people or objects being tracked, the characteristics and set up of the location, the effect of sanitization protocols, etc.

There may be other uses related to the tracking/identification of adverse incidents, using data from other systems and correlating common variables to identify patterns, trends and/or issues. A positive correlation may be useful for flagging which areas need attention, as correlation does not always lead to causation.

In relation to infection tracking, information being tracked may include staffing information, scheduling data, points of contact, vital sign information, charting, dosing, maintenance, inventory, etc.

Practitioners and/or other individuals providing treatment may be identified through various methods, such as utilizing a “recorded by field” in medical records, or their associated wireless devices (e.g., pagers, smartphones, RFID pass cards, access cards). In some embodiments, information may also be taken from various sensors, cameras, and wearable technology (e.g., smartwatches). The system may be configured to merge data from different protocols such as HL7 and CSV for example, and in combination with this data, the contextual profile may be utilized to determine location information. Additional information may also be considered (e.g. not limited to movement data), for example, as the patient may be deceased but also to indicate that there may be disease in a room, or on bed or other object, or in various historical locations. As an example, an imaging system, a test location/operating room being used by a potentially infected individual, or a registered nurse providing care to the individual may be tracked to determine various characteristics about encounters (e.g., length, type of contact, the potential for spread via bodily fluids, aerosols). A location/device may be designated as a “hot zone” for disease infection or high traffic area, for example, and in some embodiments, practitioners are warned through a wireless device (e.g., through an audible, vibratory, or visual notification) that there is a probability that this area is infected and that the practitioner should take precautions.

The contextual profiles may also be utilized by the system 200 in interfacing with external systems, such as pharmacy systems to conduct various determinations. For example, the system 200 may be utilized to associate with an individual and the individual's tracked position/position history the individual's prescription information, or current drug being administered.

The system 200 may also be utilized for determining resource allocation (e.g., beds), indicating when a bed is available/used/requires cleaning. In some embodiments, workflows are triggered that send various instructions (e.g., electronic instructions to devices) or generate various notifications (e.g., informing practitioners that a patient has left a bed, requesting cleaning, etc.

Workflows may also be used to track (directly or indirectly) various patient, staff and/or practitioner procedures, such as the movements to washing stations (e.g., by surgeons before each surgery), checking in on pre-operative procedures (e.g., did the patient move to the cafeteria prior to surgery), movements to used devices (e.g., to determine whether a device has been cleaned by cleaning staff).

The system 200 may also be utilized for determining the availability of various resources and locations thereof, such as parking facilities, doctors' appointments, medical testing devices, staff, etc., and be utilized to predict information such as wait times, etc. This information may be determined, for example, by directly or indirectly measuring and/or monitoring movements, object states, post discharge monitoring, post procedure and patient records, etc. In some embodiments, the system 200 can be used to provide contextual determinations to aid in decision making, such as indicating (e.g., through a configured interface on a mobile application) which admission desks or centers a patient should preferably attend to based on waiting time.

In some embodiments, system 200 may also be used to provide one or more maps that can be used to identify, for example, staffing issues (e.g., identifying clustering of people and comparing to healthcare outcomes), the movements of visitors, devices, equipment, staff, and/or vendors, etc. These maps, in some embodiments, can comprise a collection of location or position data points in a healthcare facility. The location or position data points can be linked to a time component to provide an additional dimension to the map data structure. These data points are contextualized based on data stored on contextual profiles such that additional values and scores may be associated with the points (e.g., infection risk probability, healthcare incident risk probability, name of individual, accessibility constraints, medications prescribed, occupation of individual, task being assigned to individual). The points can be indicative of a present position of an individual or an object, and in some embodiments, the movement of the points is tracked over a period of time to determine travelled pathways (e.g., movement of the individual or the object over time).

Risk levels associated with a point may be utilized in relation to the tracking of patients or other objects. For example, a risk level may be captured in a representative score that is determined through analysis of past data and predictive data generated by a healthcare computing backend, and may be varied, for example, based on patient mobility, strength of infection, time data, duration of a disorder or disease, identified proximity to infectious individuals, etc.

The system 200 may be used to provide a real-time visual representation of the computed map structure and generate overlays such as patients or other people who are at the hospital. The visual representation can further identify information such as whether there is equipment cluttering a hallway (e.g., impeding the path of patients with intravenous drip poles), etc. The system 200 may aggregate contextualized electronic position information with profile information stored in the contextual profile to generate at least one electronic map structure storing location and time data. The map structure can include location points, such as current locations of the one or more individuals and associating, with each of the location points, and an approximated probabilistic risk level for the corresponding individual. The map structure can include location points for different time periods. The map structure can include location points for past locations of one or more individuals.

In some embodiments, system 200 is configured to conduct classification determinations based on tracked information from contextual profiles, such as movement data as aggregated from multiple individuals and other entities, such as conveyance means (e.g., elevators), devices (e.g., dialysis machines), and/or objects (e.g., hospital beds). This functionality is particularly useful where current maps are inaccurate or static, without classifications. The classifications may be made, in some embodiments, based on the application of business rules, the business rules providing a probabilistic determination of a classification based on the application of logic in relation to the tracked information (e.g., having a weighted average with a cut-off threshold, using various heuristics to differentiate), etc.

The classifications may be used to identify, for example, what a location is, what an object is, what a fastest route is in view of particular parameters (e.g., accessibility requirements), quiet areas at particular times, etc. Classifications may also be temporary in nature, for example, where a spill has been identified in a location, the area may be classified as temporarily unavailable and individuals may be preemptively directed away from the location, through, for example, the establishment of detours and/or alternative pathways.

The system 200 may be configured to generate contextual profiles based on sensed, provided, and/or derived information associated with various processes, objects and/or facilities. The contextual profile may be based on location, movement, and/or positional information (e.g., a generated “map”, which may be location-based or otherwise).

For example, one or more contextual profiles may be used to dynamically generate a three dimensional (3D) map of a facility. Accordingly, position or location data may include 3D or 4D coordinates (e.g., in various types of coordinate systems such as cylindrical coordinates, spherical coordinates, Cartesian coordinates), at different time points, and/or other 3D positional data at different time points.

The 3D position data may be aggregated to dynamically generate a 3D map over time, or in a near-real or real-time manner. The map may indicate the location of various objects, individuals and/or equipment, and may also include information such as traffic levels, congestion, location properties, accessibility information, infection information, access to pharmaceuticals, access to healthcare tools (e.g., scalpels, hypodermic needles), etc. In some embodiments, static maps (e.g., maps having static information, such as physical maps, blueprints, some electronic files) may be used as an initial input and used to compare and/or correlate to a dynamic map generated by an analysis of the contextual profiles.

For example, the dynamic maps may include time-variant information indicating that various locations and/or objects may have moved and/or otherwise been physically altered over a period of time. The time data may be linked to position data points for an entity. A potential benefit may be a more accurate map as static maps often do not reflect changes that have occurred since their creation (e.g., a new ward was added, an old storage room was repurposed as a pharmaceutical inventory room, a room has since been modified for negative pressure airflow systems), etc. In some embodiments, these dynamic maps may be used to generate updated static maps. The dynamic maps may be used, for example, to generate various 3D maps that are also varying over a period of time (e.g., a 4-D map, where the fourth dimension is time).

The contextual profile may be used, for example, to conduct real-time contact tracing, in which various individuals, objects, and/or equipment are tracked as they move about a facility.

The contextual profile may include various elements of information that may be determined and/or otherwise provided about a facility, a location, various objects, individuals and/or equipment. This information may be provided from one or more external systems, such as inventory systems, electronic health record systems, security systems, facility access systems, etc.

For example, a facility may be noted as accessibility friendly or unfriendly, a hallway may have a particular throughput of people for a time period, an object may be associated with a score for ease of mobility of the object, an individual may be noted as a practitioner having various qualifications, equipment may be noted as requiring a particular power source and/or sterility requirements. For example, information and/or data may represent movement at different floors in a building using 3D data. In some embodiments, movements through conveyancing means, such as stairs, escalators, elevators, conveyor belts, dumbwaiters, etc., may also be tracked.

As a specific example, in the context of infection tracking, there may be various characteristics associated with a location, such as the type of airflow that may be provided in a particular location. For example, the presence of positive airflow systems, negative airflow systems, quarantine chambers, isolation wards, etc. In some embodiments, the system 200 may also be configured to track aspects (e.g., via sensors) related to the status of these locations, such as the proper closure of doors (e.g., in an isolation ward), windows, ventilation systems, etc. There may be integration with various control systems that may be used to actuate the operation of devices in relation to tracked characteristics of the locations, such as a servomotor used to close a door, a magnetic connection used to implement a lock, etc.

The contextual profile may also be a data provided in the form of a data structure, metadata, etc., that may provide various elements of information related to an individual, an object, or a facility (or a portion thereof), gathered from various sources and correlated to form ‘contextual awareness’ for the environment of the user/location/device. A data structure, metadata, etc., may also be used to hold various relationship elements describing relationships (e.g., correlations, predicted, known, connection type) between various other aspects of information.

The contextual profile may be used in the generation, refinement, and/or use of consumable information using preventative, predictive, and proactive/reactive models of healthcare support systems for risk management.

There are various applications for the system 200, including the generation of multi-dimensional dynamic map data structures (which may also be referred to as maps herein), dynamic path setting (e.g., based on known and/or predicted information, a particular path may be optimal and prioritized over another), association with one or more automatic rules (e.g., determining when individuals are not regularly visited or have not moved and scheduling a visit), identifying and tracing infection patterns, predicting potential issues (e.g., slip and falls, infections), triaging and/or prioritizing traffic based on severity, adverse incident tracking, etc.

The contextual profile may potentially improve patient safety and healthcare outcomes by providing contextual, location/movement derived information in a readily usable form to practitioners. This information may be used, for example, to improve various aspects of the functioning of a healthcare facility, such as identifying efficient routing of practitioners, patients and/or machinery, mapping previously unmapped facilities, determining previously unknown correlations, etc.

In some embodiments, a probabilistic pathway may be determined that may be optimized in view of particular contextual characteristics related to a particular healthcare issue. The probabilistic pathway may be a three dimensional path whereby probabilistic waypoints may be generated based on information known about one or more potential pathways. One or more probabilistic pathways may be used to optimize and/or model pathways from one location to another location, given various characteristics and requirements (e.g., where the system identifies a number of pathways that an infected patient having critical symptoms may take to an emergency room equipped with isolation facilities, the system is configured to facilitate a determination of a pathway based on the optimization of one or more variables, such as a maximum rate of speed given that the patient is on a stretcher, quarantine requirements, reducing the amount of time the infected patient will spend near immuno-compromised patients, etc.).

The probabilistic pathways may be generated and/or analyzed on a waypoint-by-waypoint method (e.g., to reduce processing power), or in an aggregate manner. For example, a recursive algorithm may be used to determine an optimized pathway. The probabilistic pathway may be a dynamic mapping data structure, for example based on real-time or near real-time time and position data points.

In some embodiments, the analysis of infection vectors may include further factors beyond duration of potential exposure and proximity of the individual during such durations, such as patient mobility, strength of an infection, etc. These additional factors can be provided through a healthcare computing backend that, for example, is configured to run analyses to determine and/or continually refine relationships identified between various factors. In some embodiments, machine-learning and/or neural network techniques are utilized to determine and/or probabilistically estimate the strength of relationships (e.g., through correlations, cross-correlations) as there are a large number of variables whose relationships with one another is not entirely known. However, as such an analysis is computationally intensive and not always practical or feasible for computation to completion, heuristic and/or other simplifying techniques may need to be utilized to provide indications within the limits imposed by processing time and available processing power.

For example, a probabilistic pathway may provide a location service to a person having mobility challenges and an emergency condition. The probabilistic pathway may provide an optimal route through a route that is accessible, having low traffic, and with a relatively shorter distance. In a further example, a healthcare information system 200 may identify that the mobility challenged person will take precedence over a particular route and reroute a second person to a separate pathway.

Recursion may take different forms, and in some embodiments, a breadth first approach (e.g., using a recursive queue of linked nodes) may be advantageous relative to a depth first search, especially where computing resources are constrained and the entirety of a tree cannot be efficiently navigated or searched using available computing power. As more time is spent processing to determine paths, the more likely that the paths and their relevance will become stale. A potential drawback to a breadth first traversal may be that individuals having severe health risks but farther away from the practitioner may be overlooked by the search, especially if the pathway generation engine 220 is unable or does not have the computational ability to search that far before running out of time available for processing. An alternative may include the use of a depth-first approach (e.g., using a stack of linked nodes based on the contextualized profiles).

In some embodiments, understanding that traversal of nodes to generate pathways is computationally intensive, processing time and power may be utilized and run based on a point-in-time snapshot of existing contextual profile information, and run, for example, over a known period of time, such as overnight, where health events are less likely to occur. While less responsive relative to real-time processing, such an approach may be necessary to computationally traverse enough nodes or generate a sufficient number of pathways for analysis in view of finite and/or limited processing capability. The pathways may be used by system to generate the map structure. That is the map structure can be defined by a collection of pathways.

In some embodiments, tree-traversal optimization approaches are utilized to reduce the number of computations required. Optimization approaches include tree pruning, alpha-beta pruning, mini-max algorithms, branch and bound algorithms, among others. In some embodiments, where the number of nodes to be searched is sufficiently small, a brute force approach is sufficient. Factors may be tweaked as the efficacy of the system can be tracked, for example, changing the depth of search, branching factors, the implementation of heuristic improvements, etc.

These pathways may be used in various types of simulations, where historical pathways can be assessed and one or more simulated pathways can be generated to test various layouts and other optimizations for movement and layout (e.g., the movement of an object in a pathway to a storage room, freeing up the pathway for higher throughput, moving one operating room to another location, changing the designated pathway used for visitors).

Sources of information for the contextual profile include real-time or near-time contact tracing (e.g., tracking location through the use of location-based technologies, such as radio frequency identification (RFID), global positioning system (GPS), RSS, beacons, etc.), asset or device tracking, room information, admit/discharge/transfer (ADT) feeds, temperature data, medical records, survey results, laboratory test results, hospital employment records, room/appliance data (bed angles, windows), security data, human resources data, immunization records, customer feedback data, pharmacy data, radiology data, facility information (e.g., blueprints, light usage), etc. In some embodiments, data may be provided in various formats, such as Health Level Seven (HL7) compliant data formats, etc.

The information may be used to generate a profile having information which may then be consumed by various systems (e.g., communicated and/or otherwise transmitted through various APIs) or individuals (e.g., communicated through devices, such as smartwatches, smart devices, pagers). The profile may keep track of information such the type of treatment afforded to an individual, an individual's mobility requirements, whether an individual is an infection risk, time associated with various events, their laboratory results, the route taken by an individual, the status of an individual, the medical history of an individual, previously visited locations by the individual, recorded mood profiles, etc.

Example uses cases include tracking infections by determining which people were in proximity with an infected person in elevators, corridors, etc., sending notifications (e.g., audible notification, visual notification) as individuals enter/exit rooms, tracking infection risks, tracking room/device cleaning conditions (e.g., a hand washing station), providing information to practitioners (e.g., tablet notification in a room providing on-demand profile information with improved data feeds/events relevant to the care of an individual), indicating that it is has a particular characteristic or related to a particular event (e.g., it is a patient's birthday), determining which patients are underserved, using the system 200 in relation to neo-natal wards or wards with a high risk for elopement, monitoring post-operative care (e.g., infection), etc. Notifications may be sent through various interface components, such as a user interface component 104 and/or an administrative user interface component 106 that are connected and/or otherwise associated with various computing devices.

Another example use case includes the use of the contextual profile to assess the reliability of records and/or recorded information. For example, a practitioner may indicate that a clinical round was completed and the practitioner checked on a high risk patient. The contextual profile may, in some embodiments, be used to verify that the practitioner did in fact visit the patient and conducted the necessary tasks.

The particular rules used to generate user profiles may be tailored for each healthcare context and/or institution, for example, an institution may prefer to use a subset of inputs or specific pre-processing rules when generating profiles, such as ADT, surgery and/or infection history. Rules may also be generated to tailor notifications (e.g., when to notify, at what threshold). Various scores may be generated, such as a risk score, a harm score, and an infection score to compare to defined thresholds to trigger alerts. In some embodiments, specific institutions may have institution-specific and/or customized rules.

In some embodiments, data mining techniques are used to identify various trends (e.g., when the furnace starts up, there is an increase of contamination in equipment due to the steam release).

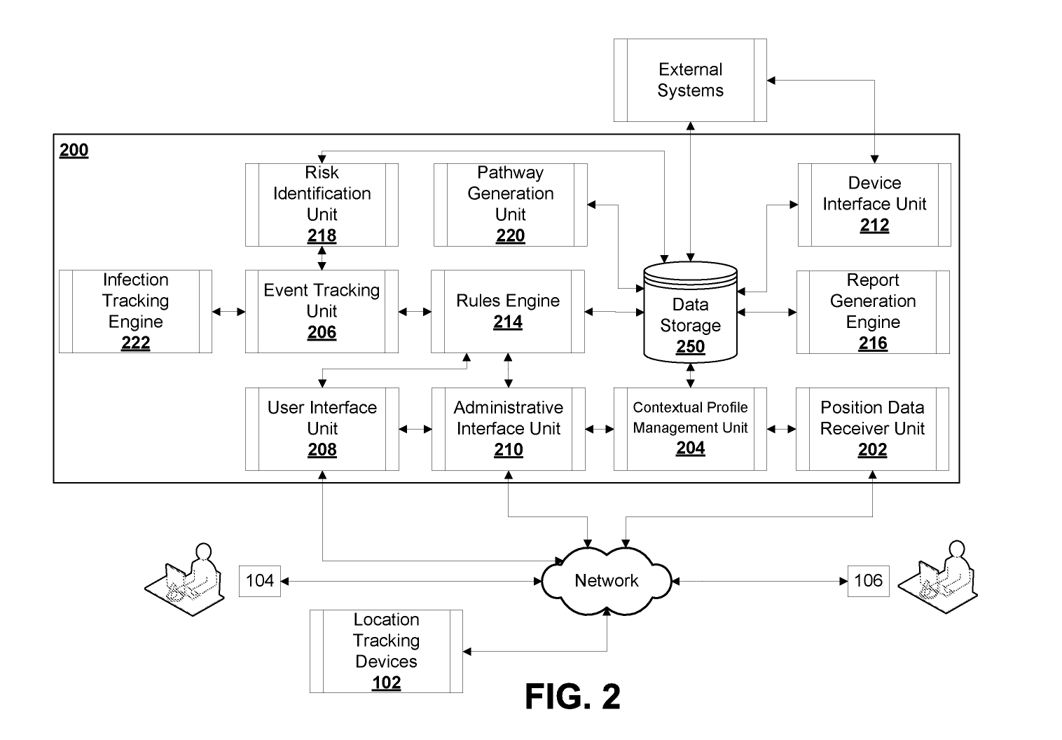

FIG. 2 is a schematic block diagram of a system for generating a contextual profile in the context of a healthcare environment, including various utilities that may be used in the implementation of the system, according to some embodiments.

The system 200 may be provided in various forms using particularly configured hardware, and includes electronic implementation through the use of various computing equipment, such as servers, data storage devices, processors, interfaces, non-transitory computer readable memory, etc. The system 200 may also be provided in the form of instructions stored upon non-transitory computer readable memory, which when executed, cause the processors to perform various steps.

In some embodiments, the system 200 is provided through a set of backend computing equipment that provide various interfaces for configuration, data processor for dynamic mapping, use and/or interfacing with external systems. For example, such a system 200 may be provided as part of a hospital data center.

In some embodiments, system 200 is provided through a set of distributed computing devices connected through a communications network. An example of such a set of distributed computing devices would be what is typically known as a ‘cloud computing’ implementation. In such a network, a plurality of connected devices operate together to provide services through the use of their shared resources. A cloud-based implementation for processing and analysis may provide: openness, flexibility, and extendibility; manageable centrally; reliability; scalability; being optimized for computing resources; having an ability to aggregate information across a number of contextual profiles, etc. While embodiments and implementations of the present invention may be discussed in particular non-limiting examples with respect to use of the cloud to implement aspects of the system platform, a local server, a single remote server, a software as a service platform, or any other computing device may be used instead of the cloud.

The system 200 may be comprised of various utilities, the utilities including but not limited to a position data receiver unit 202, a contextual profile management unit 204, an event tracking unit 206, a user interface unit 208, an administrator interface unit 210, a device interface unit 212, a rules engine 214, a report generation engine 216, a risk identification unit 218, a pathway generation unit 220, an infection tracking engine 222, and a data storage 250. Various utilities and components may be linked and/or communicate through a network.

There may be other types of utilities, different utilities, and/or alternate utilities and the utilities described are provided for example purposes. The examples are not meant to be limiting.

The position data receiver unit 202 may be configured to receive and/or otherwise be provided various elements of information associated with the position of one or more individuals, objects, or equipment. The position information may include, for example, a location, an orientation, an altitude, a velocity, an acceleration, a jerk, a snap, a bearing, etc. The positional information may be defined with absolute metrics (e.g., GPS coordinates) or in relative metrics (e.g., distance to a beacon, distance from a wall).

The positional information may be directly provided, or indirectly determined, using various processing components. For example, in some embodiments, positional information is directly provided through the provisioning of coordinates. In some embodiments, positional information is indirectly determined through the measurement of other information, for example, signal strength may be used to triangulate position information based on signal strength from a number of different receivers, a time to respond to a message may be used to determine the distance from a broadcasting station, etc.

The position data receiver unit 202 may be configured to receive information from position tracking devices 102 such as mobile devices (e.g., smartphones, smart watches, tablet computers, beacons), etc. Position information may also be provided from asset/inventory databases (e.g., the dialysis machine is always in room 301).

The position data receiver unit 202 may be configured to interpret received information and transform the information in a form and manner suitable for increased ease of access and/or use (e.g., transforming the received data into usable data sets or n-tuples).

The position data receiver unit 202 may receive information in various forms, such as GPS coordinates, cellular signal strength, accelerometer readings, gyroscope readings, wireless signal strength, the use of location-based services, triangulation readings, Subscriber Identity Module (SIM) based readings (e.g., round-trip readings), crowdsourced data (e.g., WiFi based indoor positioning), LTE functionality (e.g., Enhanced Cell ID, Observed Time Difference of Arrival), manually input information, among others.

Other position information may include, for example, facility access information (e.g., a practitioner, upon entering a secured lab, is required to use a pass-card to verify and/or gain access to the secured lab), check-in beacons (e.g., a practitioner, upon entering an operating room, is required to use a computing device to “check-in”).

The position data receiver unit 202 may be configured to provide position information to a contextual profile management unit 204. The position data may be linked to timestamp data to provide an addition dimension to the position data.

The contextual profile management unit 204 is configured to generate and/or maintain one or more contextual profiles, each of the contextual profiles corresponding to an entity such as an individual (e.g., a patient), an object (e.g., a light source), a facility (e.g., a hospital ward), or equipment (e.g., a dialysis machine). The contextual profile is an electronic profile that is generated to contain various data elements of information known and/or otherwise determined about the entity.

Types of data elements may vary, and, for example, may include health data such as temperature, complaints, symptoms, pulse, blood pressure, blood sugar, enzyme levels, age, date of birth, immunization status, travel records, medication status, etc., and also other data such as facility access data, security data, purchase data, laboratory results, customer feedback, etc.

The data elements may be associated with various levels of confidence (e.g., some information is known with a high level of certainty, such as the age of a patient, while other information may be unreliable and/or potentially outdated). The data elements stored relating to one entity may include a number of relationships between elements of data, and the information may also be related across a plurality of entities. The elements of data may be associated with timestamps indicating, for example, when the data was obtained and/or when a particular event occurred.

The one or more contextual profiles may be updated over a period of time, for example, in an asynchronous, a synchronous, periodic, on-demand manner. The linkages (e.g., associations) formed between various elements of data stored in the contextual profiles may result in linked changes that occur across a plurality of data elements and/or across a plurality of contextual profiles.

Contextual profiles may be aggregated and correlating to generate dynamic mapping data structures. The contextual profiles may include real-time and near real-time data and updates to contextual profiles may in turn trigger corresponding updates to dynamic mapping data structures.

The contextual profiles may include information such as position data, known data about an entity (e.g., information known about a patient through the patient's electronic health records, such as age/date of birth, known allergies, known conditions, current medication, laboratory test results), probabilistic data that may be inferred about an entity (e.g., a patient spends a substantial amount of time in the vicinity of the fracture clinic so there is a probability that the patient may be waiting to see a fracture specialist), etc. In some embodiments, information may also be manually provided, such as answers from questionnaires (e.g., did you travel to a farm recently?), observed information (e.g., a nurse notices that a patient's skin color is yellowish), etc.

Information or data stored relating to equipment and/or other devices may include various aspects related to the operation and/or use of the equipment and/or other devices, such as on/off status, appliance information (e.g., bed angles, windows), sanitation status, flow rate (e.g., for a dialysis machine), consumable supply (e.g., quantities of dialysate available), height, weight, accessibility, configuration, model, historical issues, age, etc.

Context, as it relates to the profiles, for example, may refer to a role (e.g., a doctor or a nurse), a location (e.g., a hospital room), a plan (e.g., a course of treatment), a route (e.g., along a path identified for high-risk trauma patients), etc.

In some embodiments, the contextual profiles may track position information associated with a particular entity over a period of time to generate a contact tracing map. For example, a known pathway can be developed for a particular entity, and/or a predictive pathway based on various factors and/or scenarios (e.g., a surgeon takes a particular path to an operating room when treating an emergency patient). Pathways may be electronic representations of physical pathways in healthcare organizations, and may represent physical elements such as hallways, corridors, steps, stairs, conveyance means, rooms, courtyards, doorways, etc.

The contextual profile management unit 204 may be configured to interface with external systems, such as an electronic health record management system, a pharmaceutical record system, an electronic inventory system, a facility security system, a work scheduling system, an adverse event reporting system, a healthcare incident prediction system, etc.

In some embodiments, the contextual profile management unit 204 monitors the movement and position information associated with an entity to facilitate various types of analyses, such as real-time contact tracing, the development of heat maps, the indirect mapping of a facility, the validation and/or verification of activities undertaken by entities (e.g., a practitioner conducting clinical visits of high risk patients, a patient travelling to a hospital pharmacy to pick up medication), the tracking of infections and/or allergens, the tracking of events and/or adverse reactions, etc. The contextual profiles may be stored in data storage 250.

In some embodiments, the contextual profile management unit 204 is configured to provide various automated map features of healthcare organizations, based on pathways identified through contextual profiles. For example, a relatively accurate 3D model of a facility (e.g., a hospital) may be generated at a reduced cost by overlaying pathways taken by patients, caregivers, devices etc. Where enough data is gathered, the system may be capable of identifying patterns of movement, such that, for example, the system may be configured to apply algorithms to identify a “patient room”, “hallway”, “visitor area”, etc.

In some embodiments, the contextual profile management unit 204 is configured to provide situational awareness features wherein, for example, contextual-based alerts and/or notifications (e.g., those related to relating to feedback, incidents, infections, claims, root cause or peer review) may be provided to various practitioners and/or caregivers. These contextual-based alerts may be provided based on sensed information related to an entity, for example, where the system determines that the entity has entered a particular room, such as an operating room.

As an example, a risk manager may be provided various tasks related to risk verification tasks based on the particular context of the risk manager. In this example, a risk manager may only have 20 minutes of available time and while the risk manager is on the 3rd floor, the risk manager is provided a list of tasks that the risk manager may attend to in the available time period.

The user interface unit 208 may be provided to exchange data with a user interface component 104 and/or an administrative interface component 106 such that one or more individuals may be able to access the system 200 and/or the contextual profiles managed by the contextual profile management unit 204 through various types of user interfaces, such as a web interface, a specialized application, a mobile application, a mainframe computing system, etc.

The interface components may be provided such that individuals are able to view, update and/or monitor various aspects associated with contextual profiles. In some embodiments, the interface components may be configured such that individuals may be able to run various types of analyses, run queries and request the generation of various reports. In some embodiments, the user interface unit 208 may be configured to issue and/or generate various notifications, for example, notifications that can be provided to various entities and/or their associated computing devices.

The user interface unit 208, for example, may be accessed by a practitioner using a user interface component 104 on a computing device in a waiting room to review information associated with an entity (e.g., a patient), such as clinical data that is linked to near-real or real-time location data.

The administrator interface unit 210 may be provided to expose, control and/or display an administrative interface component 106 to send commands and data. The administrative interface unit 210 and the administrative interface component 106 may permit one or more administrators the ability to modify and/or otherwise manage various aspects of the system 200, such access to the contextual profiles managed by the contextual profile management unit 204. For example, the administrators may be able to modify how users interact with the user interface, various levels of permission, the availability of information (e.g., in compliance with various regulatory and/or legal requirements, such as privacy legislation), etc.

The device interface unit 212 may be provided so that the system 200 may communicate with various types of devices, such as medical equipment, tablet computers, beacons, etc. For example, a hospital bed may include one or more position sensors, as well as other sensors for measuring information related to a patient who is using the hospital bed.

This information may be provided through various APIs to the device interface unit 212, which then provides the information in a form to be used by the contextual profile management unit 204 in tracking and/or updating contextual profiles associated with the various entities, such as the hospital bed and the patient. In some embodiments, the device interface unit 212 may be configured to issue and/or generate various notifications, for example, notifications that can be provided to various manufacturers, to various entities (and/or their related computing devices), for example, indicating that a device must be sanitized before another use.

The rules engine 214 may be provided to generate, apply, and/or update one or more rules that may be used in the generation and/or maintenance of contextual profiles.

These rules may, for example, be logical rules that may be based on various triggers, such as the occurrence of events, the modification of information related to a particular entity, the passage of time, etc. The rules may be associated with particular contextual profiles or particular elements of information, and may be used to generate relationships, modify relationships, etc.

The risk identification unit 218 may be configured to apply one or more rules in determining when am adverse event or incident and an associated risk or likelihood of occurrence is more or less likely to occur based, at least in part, on information tracked in the contextual profiles. For example, a rule may be provided to identify a risk where a practitioner indicates on a manual system that clinical follow ups have been conducted but positional information indicates otherwise, or a patient has not travelled to a hospital pharmacy to pick up medication following a course of treatment. Various different levels of risk can be identified (e.g., based on seriousness of an adverse outcome), with differing levels of confidence (e.g., providing a confidence score). In some embodiments, the level of risk and the level of confidence associated with a risk may be used to determine a holistic risk rating (e.g., based on an expected value). Electronic indicia relating to one or more risks and/or other associated information or metadata may be stored in data storage 250. In some embodiments, the risk identification unit 218 may be configured to utilize probabilistic models and/or predictive models that may be refined over time/repeated events to determine that a risk is present.

The pathway generation unit 220 may be configured to track the position information of an entity over a period of time and generate one or more pathways (e.g., a set of positions and/or locations over time or at different time points) associated with that entity. The pathways may be predictive based on known and/or inferred information. Electronic pathways may be generated and/or monitored for the entities and used in various applications, such as infection tracking, facility mapping, contact tracing, accessibility determinations, etc.

Pathways may be also be generated for entities to indicate an optimized pathway in view of various circumstances (e.g., a doctor is seeking the fastest way to bring a large-sized trauma patient on a stretcher to an available operating room having a surgical boom designed to accommodate a larger patient).

The one or more pathways identified and/or determined may be stored in data storage 250, and may be comprised of various elements, such as waypoints, timestamps, coordinates, etc. Pathways may also be generated to develop various types of maps of facilities, for example, generating heat maps based on most frequently used pathways, identifying areas of traffic congestion, etc.

In some embodiments, the pathway generation unit 220 may also be configured to develop one or more simulated pathways for simulated individuals, objects and/or equipment. These pathways may be generated based on behaviour models (e.g., probabilistic models identifying decisions, travel speed, accessibility requirements, role, and infection status). The simulated pathways may be used in aggregate to determine the feasibility (e.g., by establishing a feasibility score) of various layout options, etc. The accuracy of the simulations may be refined over time, for example, by reviewing simulated pathways against actual pathways (e.g., simulating pathways before a layout change and then measuring the actual pathways following the layout change). The pathway generation unit 220 may be configured to generate visualizations using electronic map structures that may be updated in real or near-real time, for example, in response to received information or updated contextual profiles. For example, such an electronic map structure may be overlaid and/or otherwise superimposed on to existing facility maps such that location features may be more readily identified, such as accessibility, doors, width of hallways, location of equipment and/or facilities, etc.

The pathway generation unit 220 may be configured to generate pathways where the locations of objects or individuals are used as nodes in a pathway. Path traversal costs may be associated between nodes based on facility information stored on data storage 250, as input into the system 200 or derived from facility maps and/or stored location features, such as slopes, doors, average travel times, etc. Where the nodes are individuals, each of the nodes may also be associated with an approximated probabilistic risk level for each individual that is re-weighted based at least on distance from the location of a particular healthcare practitioner.

For example, an initial practitioner location-contextualized electronic map may be generated for a specific healthcare practitioner (e.g., through the superimposing of the facility map information), and the approximated probabilistic risk level can be reweighted so that nearby health risks are prioritized. This approach can help to actively providing treatment to those individuals in a location context manner, while being realistic in relation to the amount of treatment being able to provide in a particular period of time, taking into account travel time between individuals. A challenge for healthcare providers is determining, in a limited timeframe, how to best allocate limited time resources without having the ability to undergo extensive analysis of schedules.

In some embodiments, pathway generation unit 220 is configured to utilize the tracked location data of individuals or objects in conjunction with their stored contextual profile to generate a visualization of the healthcare facility. For example, the location data can be provided in the form of points in a three-dimension or two-dimensional space, which may be absolute or relative. The points may be in the form of geospatial relationships between the points. As the points move around the two-dimensional or three-dimensional space, the pathway generation unit 220 is configured to track the movement to generate pathways. These pathways may be “frames” of movement, time-coded and/or associated with contextual data (e.g., with timecoded metadata) so that the pathways can be analyzed.

For example, the pathway generation unit 220 may, over a period of time, track the pathways of all individuals in the healthcare facility, and classify the pathways based on various factors and/or combination of factors. The pathways can be used to determine what, for example, pathways are utilized by accessible-needs individuals, emergency care practitioners, individuals coming to the healthcare facility for a particular type of procedure, the ingress/egress pathways for different types of patients, pathways being used by practitioners during break times, pathways being used by practitioners to respond to various types of codes, etc.

In some embodiments, the pathways are utilized to generate a mapping of the facility using the geospatial relationships. The “mapping” of the facility may be different than a traditional map in that the mapping is developed based on the pathways taken by the individual along with their contextualized profiles with their tracked location information.

In some cases, a map generated using the geospatial relationships may be more useful than a traditional facility map. The generated map, for example, may be indicative of what pathways and locations individuals actually use in carrying out their day to day tasks, and different maps may be generated based on different segmentations of data. For example, a map that is generated based on nurse geospatial information may be very different from a map generated on patient geospatial information, doctor geospatial information, or object geospatial information.

These maps may be updated in real-time, such that analyses may be conducted based on the data. For example, a visual representation may be created to determine which hospital beds are actually in use at a given time, etc. Additional visualizations may be overlaid on to the generated mappings to indicate, for example, a duration of time spent in a bed (e.g., which may be relevant for determining if bed sores are a risk), contextual information obtained from other sources (e.g., the presence of a central line, a risk for infection, latest laboratory results or surgical procedures), etc.

The information may be applied to determine, for example, compliance with hand hygiene protocols (e.g., did the practitioner approach the hand washing station), outcomes can be verified against tracked healthcare incident data (e.g., was there a corresponding outbreak or reduction of infection based on the level of compliance with hand washing protocols).

The system 200, may be configured such that one or more pathways are generated (e.g., recursively) wherein reweighting is conducted to help aid in determining and/or generating routing decisions (e.g., through the automatic generation of routing directions, calendar entries, task directions), or visualizations. These pathways may further be updated based on tracked infection information, and in some embodiments, tracked infection information is utilized to modify risk ratings and/or expected durations of treatment. In this context, the pathway generation unit 220 is also configured to generate pathways of infected (or probably infected individuals) to identify and/or pre-emptively update and/or modify risk ratings associated with objects or individuals who may have been exposed to the infection, through communication with infection tracking engine 222.

The generation of pathways is a difficult and computationally intensive endeavour where there are a non-trivial number of potential nodes (e.g., individuals, objects). As path weights and associated information, such as risk levels, vary, determining optimal pathways from a super set of potential pathways becomes very challenging.

Computational techniques are useful in helping identify analytically superior solutions relative to conventional techniques whereby a nurse or other administrator uses his/her experience to simply identify rounds and/or schedules based on “experience”, and in embodiments described in this application, the computational power of the backend is instead harnessed to identify and automatically trigger and/or provision visualizations, notifications, and/or routing instructions, for example, based on selecting pathways having a highest cumulative treatment score based on nodes visited, the cumulative treatment scores determined based on the risk levels associated with each of the nodes.

In some embodiments, past learnings and experience may be corresponding utilized through the input of manually specified data and or weightings of factors, which may be automatically tweaked and/or refined by the system 200 as relationships between outcomes are validated, or estimated relationships are discarded over time.

Accordingly, a more efficient usage of a known duration of a healthcare practitioner's time can be provided wherein contextualized profile and location information is harnessed to provide a more effective and efficient approach based on empirical methodology and healthcare predictions.

The collective information stored on the data storage 250 backend is utilized to refine and generate more accurate predictions, which in turn can be utilized by pathway generation unit 220 and infection tracking engine 222 to generate further more accurate pathways that help ensure that improved care is provided to individuals at a healthcare facility.

In some embodiments, a greater level of accuracy is achieved where further computation power is available. For example, where there may be additional processing cycles, these processing cycles may be utilized to dynamically re-weight each of the approximated probabilistic risk levels for neighboring nodes to a current node being traversed using the distance between the current node being traversed and the neighboring nodes as pathway generation unit 220 traverses each node. However, a potential drawback with such an approach is that greater computational power may be required as a greater number of pathways are generated in view of the increased pathway complexity. Similarly, in some embodiments, pathways are re-weighted in view of infection information, and additional pathways are generated by pathway generation unit 220 for every individual that may be infected, based on infection control information including at least a prevalence of transmission, one or more identified transmission vectors, and a severity of infection.

The generation or updating of the one or more contextual profiles, in this embodiment, may further comprise identifying estimated radii of transmission based on the prevalence of transmission, the one or more identified transmission vectors, and the severity of infection of one or more infected individuals, and increasing the approximated probabilistic risk level for other individuals that were in proximity with the one or more infected individuals as determined by the estimated radii of transmission and the time coded contextual metadata tags.

The report generation engine 216 may be configured to generate one or more reports for provisioning to interface components, to individuals, administrators, or provided to various external systems. These reports may be developed based on an analysis, processing and/or transformation of various information/data stored and/or otherwise associated with one or more contextual profiles. Reports may be provided, for example, on an individual profile level, on an aggregate profile level, or in the context of particular events and/or scenarios (e.g., determining pathways taken by practitioners during a natural disaster situation). For example, the report generation engine 216 may be used to identify trends, correlations (e.g., establishing potential relationships between environmental indicators, patient safety), conduct root cause analysis, etc.

In some embodiments, the report generation engine 216 may be configured to generate various types of maps, using various information, such as ADT information. For example, a map may be generated using, among other information, ADT info on beds, equipment, and/or rooms. The information may be utilized to identify entities in a spatial representation and overlaid with time to show information such as beds having high turn-over (possibly due to the presence of an infection vector on the bed), etc.

The movement information of entities may be correlated against security system information (e.g., to identify unauthorized access to controlled access areas such as nurseries, pharmaceutical storage, biohazard waste sites), personnel records (e.g., to identify that a doctor actually visited a patient or that a patient has started wandering), hygiene records (e.g., to identify that hands were properly washed and/or sterilized equipment was used), cleaning records (e.g., to identify that devices were actually cleaned), etc. In some embodiments, reports may be generated by users to illustrate information based on their movements (e.g., “map my stay”).

These reports may be provided to other systems, for example, to cause the generation of notifications (e.g., a notification system issuing code yellow/code blues), the automatic locking of doors (e.g., a facility management system), etc.

The reports may be utilized for various uses, including, but not limited to productivity enhancement via tracking the movement of entities in real or near-real time. For example, nurses on the third floor have been recorded to repeatedly access a fridge at the end of a long hallway, which results inefficient movement as the nurses must return from the fridge when the shift ends. Such a report may be utilized to recommend a shift in layout to improve the speed of return from break. Other considerations may include, for example, wait times for elevators, patient/practitioner movement, the locking/unlocking of doors, etc. Other uses may include features provided to support patient experience, such as an ability to track visits for a patient, a patient directory where it is easy to locate a particular patient, etc.

The reports generated by report generation engine 216 may include transmitted routing information, such as routing instructions that provide at least the location of the individual associated with each electronic waypoint, an estimated duration of therapeutic treatment, and/or directions to the next electronic waypoint in the ordered list of electronic waypoints. This routing information, for example, may be provided in the form of specific electronic instructions that are provided to various devices 102 or other types of devices that may be utilized to guide individuals through a healthcare facility, and may include task information, etc. Where the routing information is provided in the form of electronic calendar entries, one or more calendar entries can be created, each of them corresponding, for example, to waypoints or nodes identified in generated pathways.

The data storage 250 may be may be implemented using various database technologies, such as a non-tabular database (e.g., a noSQL database), relational databases (e.g., SQL databases), flat databases, Microsoft Excel™ spreadsheets, comma separated values, etc. If the data storage 250 is implemented using relational database technology, the data storage 250 may be configured to further store relationships between various data records. The data storage 250 may be implemented using various hardware and/or software technologies, such as solid state or hard disk drives, redundant arrays of independent disks, cloud storage, virtual storage devices, etc.

Communication between various engines, units, external devices and/or by interfaces may occur over various networks. The networks may include the Internet, intranets, point to point networks, etc. Networking technology may include technologies such as TCP/IP, UDP, WAP, etc.

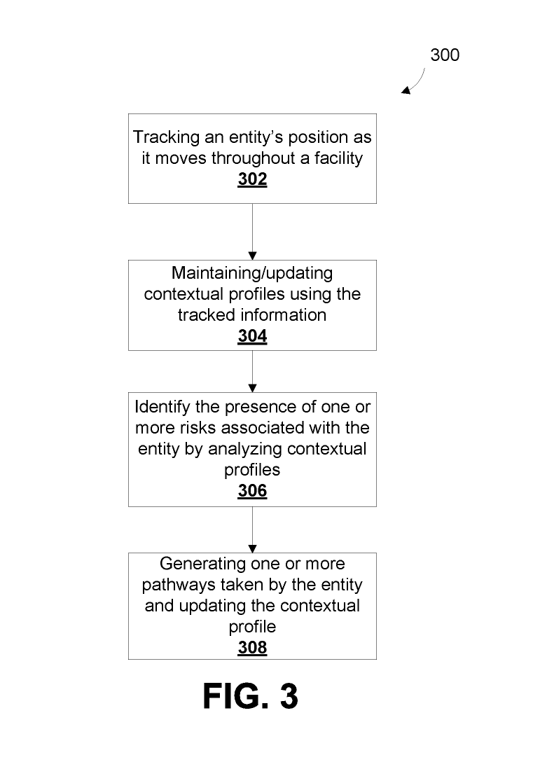

FIG. 3 is a sample workflow diagram of workflow 300 illustrating steps for maintaining a contextual profile, according to some embodiments.

At 302, an entity (e.g., an individual, an object, a facility or part thereof, or a piece of equipment) may be tracked (e.g., through recording position data elements for an associated position tracing device) as it moves, other entities move around it and/or is otherwise positioned. Position information may be determined and/or otherwise recorded and provided to the position data receiver unit 202. For example, such information may be directly provided through the provisioning of coordinates, or indirectly provided through signal strength measurements, triangulation and/or crowdsourced WiFi signals.

At 304, the contextual profile management unit 204 operates to maintain and/or update contextual profiles associated with the various entities, recording the provided position information along with other metadata, such as timestamps, flags relating to various events, etc. Where events have occurred (e.g., an incident where an individual slips and falls), events may also be tracked along with data associated with the event by the event tracking unit 206. The contextual profile may include other information known and/or inferred about an entity, such as information provided in an electronic health record, job responsibilities, medication record, operation record, surgery data, ADT data, EHR data, etc. There may be information retrieved from inventory management systems, such as instrument record logs, wheelchair check-in/check-out records, etc. In some embodiments, various individuals, instruments, equipment and medical tools may be associated with registration systems (e.g., having scan-able barcodes or identifiers), etc., and this information may be used as inputs to track entities.

For example, location identifying data such as surgery feeds (which indicate times and locations of procedures), radiology data (which indicate times and locations of procedures), ADT (which indicates specific data around admission, discharge and transfer activities), electronic health records or electronic medical records (which collect information about patient activity), and scheduling systems (including both staff and patient schedules) may be indicative or used to estimate movement (or static positions) in the a healthcare facility.

At 306, the risk identification unit 218 may be operated to utilize the contextual profile information in the various contextual profiles to identify one or more risks (e.g., risks related to adverse events or incidents) by applying one or more rules provided by the rules engine 214. The risks may be identified along with a probability of occurrence and an impact score, which may then be used to identify an overall expected risk level based, for example, by weighting the impact score against the probability of occurrence.

At 308, the pathway generation unit 220 may be operated to generate one or more pathways taken by the one or more entities during a period of time. Pathways, for example, may include one or more waypoints, coordinates, etc., and may be associated with various elements of topological representations, such as graphs, nodes, edges, etc. The pathways may, for example, the tracked on various devices held by or residing on different entities, and these devices may have identification of what a particular entity is (e.g., machine, human, hospital bed, cart holding pharmaceutical drugs) or what the role of the entity is (e.g., visitor, doctor). In some embodiments, the system 200 is configured to conduct a determination of what a particular entity is based on its tracked movements and/or profile information. For example, staff contact with multiple patients in a small zone, patients tend to be more sedentary as compare to staff that move more regularly, etc. Every set of movements, for example, may be used to record a transaction, generating a list of locations that each entity (e.g., a patient) has been, helping develop various analyses and determinations.

For example, pathway information may be used to indirectly determine how many available beds a unit has, what patients were roommates with a particular patient, identify hospital beds a patient was in contact with, what time a patient was in a bed and what time the patient left the bed, etc.

This information may be used in various ways, such as to programmatically generate visual representations of movements having overlaid disease information and other data, for example, based on a timeline.

The one or more pathways may be identified using recorded position information stored in the contextual profile of the entity, and in some embodiments, the one or more pathways may also be associated with metadata information linking pathways taken to other contextual factors, such as the time of day, the type of activity being carried out by an entity, etc. Various algorithms may be used to determine and/or generate a pathway, for example, traversal algorithms where nodes are associated with various weights, such as A* traversal, heuristic methods, Dijkstra's Algorithm, etc. Some of these algorithms and/or techniques can be utilized in various combinations with one another, in various combinations and/or permutations.

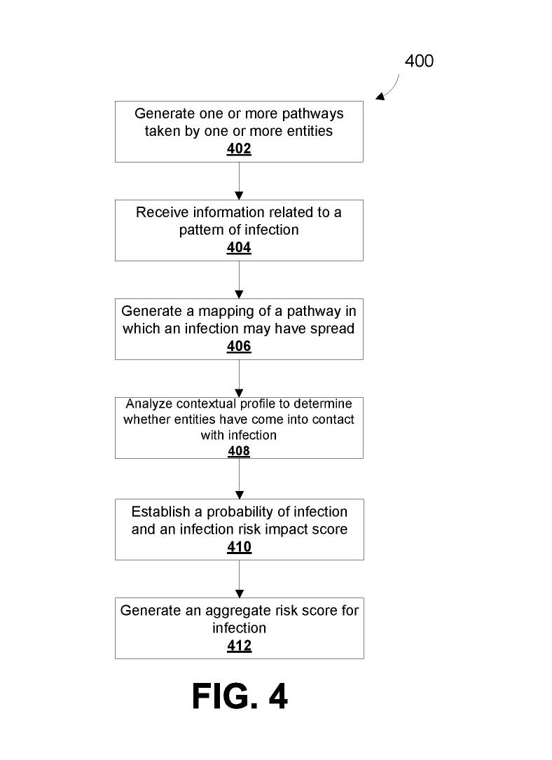

FIG. 4 is a sample workflow diagram of workflow 400 illustrating steps for conducting infection pathway analysis using at least information provided in the contextual profile, according to some embodiments.

At 402, the pathway generation unit 220 is operated to generate one or more pathways taken by the one or more entities during a period of time. The period of time is determined to be a period of time in which an infection is present in a facility.

At 404, information is retrieved from the event tracking unit 206 in relation to an outbreak or pattern of infection, including various information related to specific events that may be associated with the pattern of infection, such as the admitting of a patient with a high fever, the use of various equipment in relation to infectious disease, the use of hygiene stations/equipment, etc.

At 406, the pathway generation unit 220 is used to generate an electronic mapping of a pathway in which an infection may have spread.

In some embodiments, data provided may be overlaid to events that occur to entities, such as a patient receiving a positive/negative/inconclusive lab test (e.g., establishing an event at a point of time), x-rays, surgeries, catheter insertion and removal (duration).

This electronic mapping of a pathway, along with the mapping and/or superposition of any other information may be presented to users of the system 200 in various graphical forms (e.g., a time graph), and may be used by practitioners having expertise to analyze data to determine spread of the infection. In some embodiments, the system 200 may be configured to perform machine-based learning techniques and analyses to heuristically assess probabilities of infection. Such an approach may be particularly beneficial where there is a large set of data points having interrelations between some of the data points. The data may be continually refined as more data is received, helping to better identify (i) possible causes and transmission pathways such that lead to the spread of infection, or (ii) events that are effective to prevent the spread of infection.

For example, practitioners may be able to investigate infection spread by searching for entities (e.g., individuals, objects, equipment) that are suspected of passing on a disease or acquiring a disease and may consider issuing a notification and/or issuing commands to isolate the entity to prevent further transmission.

In some embodiments, an infection pathway may be generated having both a three-dimensional spatial representation and also having a time dimension, potentially allowing users of the system 200 to track the spread of an infection over both time and space. This data may be integrated with claims, incidents, and lab results, for example, positive test results may in the system focusing in on a particular patient to control movements in an attempt to stop an outbreak.

The rules engine 214 may be used to apply various rules in determining when and at what periods of time a pathway should be considered associated with infection. The particular rules may vary depending on the context of the infection (e.g., having a larger area for more infectious diseases). For example, various entities associated with infections may have their pathways traced and/or aggregated.

At 408, the rules engine 214 applies one or more rules associated with determining whether an entity has come into the proximate area of infection during a relevant period of time (e.g., when an infected person moved through a corridor). The various contextual profiles may be accessed and location information may be reviewed in determining whether a particular entity has been potentially infected. Other types of determinations may also be made, including, for example, individuals that an infected person had contact with (e.g., sharing an elevator, a hallway), devices and/or equipment that may have been used, etc. In some embodiments, various pathway nodes may be identified and/or associated with a path taken by an infected or probably infected entity and these infected pathway nodes may be used to determine where another entity may have crossed paths with the infected or probably infected entity. For example, the pathways taken by an entity may be reviewed and overlaid with other pathways (e.g., pathways of infected or probably infected entities). This information may be supplemented by other information, such as ADT (admission discharge transfer) data. The process may be iterated to continually identify infected or probably infected entities.

At 410, the contextual profile management unit 204 may be utilized to establish a probability of infection, as well as establish an infection risk impact score based on the severity of an infection (e.g., influenza would likely have a lower score than ebolavirus).

At 412, the contextual profile management unit 204 may be utilized to generate an aggregate risk score for infection, for example, based at least on a probability of infection as well as the infection risk impact score. The aggregate risk score, for example, may calculate aspects based on lab results, unit testing once the patient has been discharged, signs and symptoms of a patient in a unit, survey and/or information captured in admission questionnaires, among others. The potential admission source may be taken into consideration (e.g., from a particular nursing home) and information may also be received (e.g., from third party sources) that indicate outbreaks from nursing home, etc. For example, if a public health department provides a report each day of outbreaks and location, this report information may be provided to the system 200 and correlated against historical data linked to various entities to conduct various determinations related to infection control.

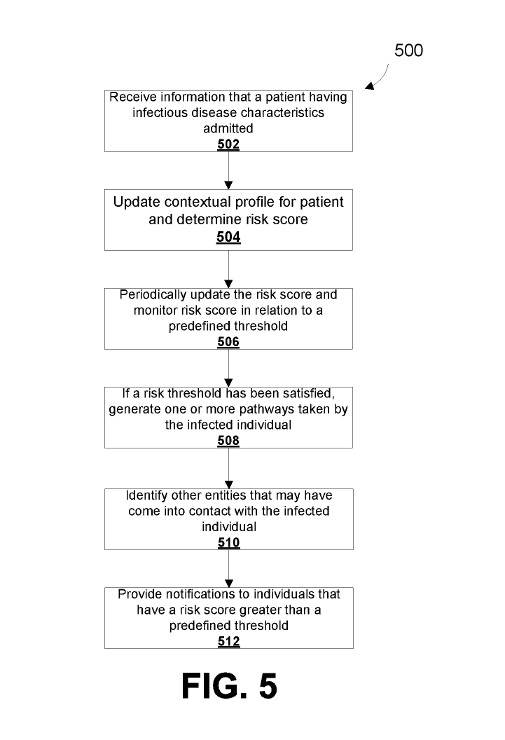

FIG. 5 is a sample workflow diagram of workflow 500 illustrating steps for infection control using at least information provided in the contextual profile, according to some embodiments.

At 502, the pathway generation unit 220 receives information that a patient having various infectious disease characteristics has been admitted. Information such as disease type (e.g., ebolavirus), contagiousness (e.g., probability that an exposed person is infected), contagion vectors (spread by bodily fluids), disease impact (e.g., high likelihood of fatality in infected patients), disease probability (e.g., percentage chance that a patient actually does have ebolavirus given the patient's travel patterns and/or test results), etc., may also be provided. The information is maintained and/or updated by the contextual profile management unit 204.

At 504, as various conditions change, the contextual profile may be updated for the patient. For example, positive/negative test results may be obtained, the patient's condition may be deteriorating, the patient's blood pressure is decreasing, the patient's heart rate is increasing, etc. An overall risk score may be maintained by the risk identification unit 218 and regularly updated as conditions change over time.

At 506, the risk identification unit 218 monitors the risk score and determines that a risk score has increased beyond a particular threshold, e.g., through the application of a rule by the rules engine 214.

At 508, the pathway generation unit 220 is operated to generate one or more pathways taken by the one or more entities during a period of time, including at least entities related to the infection (e.g., infected individuals).

At 510, the contextual profile management unit 204 and the rules engine 214 may be configured to apply various rules in conjunction with information stored in various contextual profiles to identify entities which may have come into contact with (or were in a particular proximity to) the entities related to the infection (e.g., equipment, people crossing paths in hallways, people coming near/or in contact with bio-hazardous waste).

The risk identification unit 218 may be utilized to determine an infection risk score for each of these entities. The infection risk score may be based, for example, on the number of risk factors included, the probability of infection associated with various risk factors (e.g., using a weighted average).

At 512, the user interface unit 208 may issue a notification to individuals having an infection risk score greater than a particular threshold, for example, through their smart devices, through a facility's intercom system, through notifications based on the area of a facility that an individual is in, etc. An infection risk score may also be applied to pieces of equipment, for example, flagging a particular intravenous drip apparatus for specialized cleaning and/or disposal. In some embodiments, the user interface unit 208 may also be configured to notify (e.g., through an audible or a visual notification) a particular entity of his/her infection status (e.g., the contextual profile for the patient has been updated in view of the patient's positive test results, and a notification is issued to instruct the patient to report to a quarantine location).

With respect to computer-implemented embodiments, the description provided may describe how one would modify a computer to implement the system or steps of a method. The specific problem being solved may be in the context of a computer-related problem, and the system may not be meant to be performed solely through manual means or as a series of manual steps. Computer-related implementation and/or solutions may be advantageous in the context of some embodiments; at least for the reasons of providing scalability (the use of a single platform/system to manage a large number of activities); the ability to quickly and effectively pull together information from disparate networks; improved decision support and/or analytics that would otherwise be unfeasible; the ability to integrate with external systems whose only connection points are computer-implemented interfaces; the ability to achieve cost savings through automation; the ability to dynamically respond and consider updates in various contexts (such as in the event of a healthcare emergency that is rapidly changing over time); the ability to apply complex logical rules that would be infeasible through manual means; among others.

Using electronic and/or computerized means can provide a platform that may be more convenient, scalable, efficient, accurate, and/or reliable than traditional, non-computerized means. Further, many systems for tracking healthcare information may be computerized and the platform may advantageously be designed for interoperability, and manual operation may be difficult and/or impossible.

The embodiments of the devices, systems and methods described herein may be implemented in a combination of both hardware and software These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components.

Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

For simplicity only one computing device 600 is shown but system may include more computing devices 600 operable by users to access remote network resources 600 and exchange data. The computing devices 600 may be the same or different types of devices. The computing device 600 at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

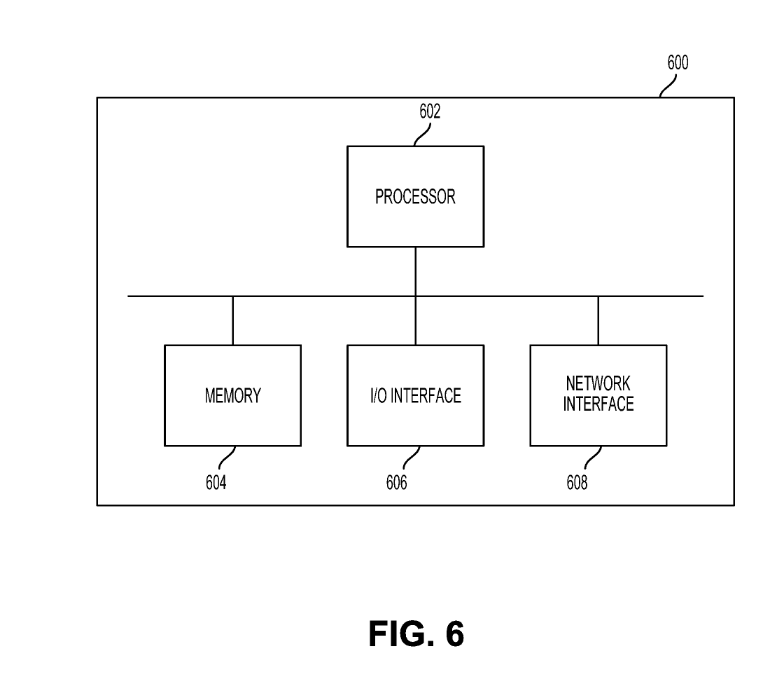

FIG. 6 is a schematic diagram of computing device 600, exemplary of an embodiment. One or more of computing device 600, for example, may be used to implement system 200. As depicted, computing device 600 includes at least one processor 602, memory 604, at least one I/O interface 606, and at least one network interface 608.

Each processor 602 may be, for example, an x86 or x64 architecture processor, an ARM processor, or a microprocessor or microcontroller or combinations thereof.

Memory 604 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 606 enables computing device 600 to interconnect with one or more input devices, such as a keyboard, mouse, camera, touch screen and a microphone, or with one or more output devices such as a display screen and a speaker.

Each network interface 608 enables computing device 600 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing device 600 is operable to register and authenticate users (using a login, unique identifier, and password for example) prior to providing access to applications, a local network, network resources, other networks and network security devices. Computing devices 600 may serve one user or multiple users.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computer-implemented method, the method comprising:
receiving or continuously monitoring electronic position information associated with one or more entities within a healthcare facility during a duration of time, the electronic position information obtained through one or more location tracking devices or wireless signal triangulation or a GPS receiver of one or more client computing devices, each client computing device corresponding to one of the one or more entities and acting in concert with a computational backend server residing in a healthcare data center;
transforming, by the computational backend server, the electronic position information by appending one or more time coded contextual metadata tags to the electronic position information to generate contextualized electronic position information, the one or more contextual metadata tags appended when one or more electronic trigger conditions are satisfied;
generating or updating one or more contextual profiles, each of the one or more contextual profiles corresponding to one of the one or more entities with the contextualized electronic position information, each of the one or more contextual profiles including at least a computationally approximated probabilistic risk level that is updated when the one or more contextual profiles are updated or generated;
aggregating, by the computational backend server, the contextualized electronic position information with profile information stored in the contextual profile to generate at least one electronic map structure storing, as location points, current locations of the one or more entities and associating, with each of the location points, the approximated probabilistic risk level for the corresponding individual, the map structure including one or more pathways; and
generating a visual or an audible notification on a computing interface linked to the computational backend server if the approximated probabilistic risk level of any individual is greater than a predefined threshold.

2. The method of claim 1, wherein the method further comprises:
generating a visualization of the at least one electronic map structure; and
updating, in real-time, the visualization of the at least one electronic map structure as the one or more contextual profiles are updated or generated.

3. The method of claim 2, wherein the computational backend server is adapted for generating electronic task routing signals for a healthcare task scheduling system and the method further comprises:
receiving signals representative of the location of a healthcare practitioner and a duration of availability;
superimposing a facility map and the at least one generated electronic map structure storing the current locations of the one or more entities as nodes, wherein the approximated probabilistic risk level for each individual is re-weighted based at least on distance from the location of the healthcare practitioner, the superimposing generating an initial practitioner location-contextualized electronic map structure.

4. The method of claim 3, the method further comprising:
generating an electronic map visualization of the initial practitioner location-contextualized electronic map structure wherein the re-weighted approximated probabilistic risk levels corresponding to each node are continuously monitored and a visual representation of the re-weighted approximated probabilistic risk level of each node is automatically resized or recolored based on the magnitude of the re-weighted approximated probabilistic risk level of the node.

5. The method of claim 3, the method further comprising:
generating an electronic prioritized list, based on the initial practitioner location-contextualized electronic map structure, providing an ordered list of nodes ranked in accordance to the re-weighted approximated probabilistic risk level of the node.

6. The method of claim 5, further comprising updating the electronic prioritized list responsive to updated or generated contextual profiles.

7. The method of claim 3, the method further comprising:
using the initial practitioner location-contextualized electronic map structure as an initial state, recursively generating candidate pathways starting from the location of the healthcare practitioner and visiting a subset or all of the nodes as available during the duration of availability, wherein each of the candidate pathways has a cumulative treatment score based on the approximated probabilistic risk level associated with each node visited and each node visited is stored as an electronic waypoint in an ordered list of electronic waypoints;
selecting a single candidate pathway having a highest cumulative treatment score; and
generating, in accordance with the selected candidate pathway and the ordered list of electronic waypoints, one or more routing instructions for transmission to a client computing device associated with the healthcare practitioner, the one or more routing instructions configured for automatically populating an electronic scheduler on the client computing device such that the healthcare practitioner is instructed to visit each of the electronic waypoints in the selected candidate pathway.

8. The method of claim 7, wherein the recursively generating of the candidate pathways further includes re-weighting each of the approximated probabilistic risk levels for neighboring nodes to a current node being traversed using the distance between the current node being traversed and the neighboring nodes.

9. The method of claim 7, wherein the one or more routing instructions provides at least the location of the individual associated with each electronic waypoint, an estimated duration of therapeutic treatment, and directions to the next electronic waypoint in the ordered list of electronic waypoints.

10. The method of claim 7, wherein the computationally approximated probabilistic risk level includes infection control information, the infection control information including at least a prevalence of transmission, one or more identified transmission vectors, and a severity of infection; and
wherein the generation or updating of the one or more contextual profiles further comprises identifying one or more estimated radii of transmission based on the prevalence of transmission, the one or more identified transmission vectors, and the severity of infection of one or more infected entities, and increasing the approximated probabilistic risk level for other entities that were in proximity with the one or more infected entities as determined by the estimated radii of transmission and the time coded contextual metadata tags.

11. A healthcare information tracking system, the system comprising:
a position data receiver unit configured to receive or continuously monitor electronic position information associated with one or more entities within a healthcare facility during a duration of time, the electronic position information obtained through one or more location tracking devices or wireless signal triangulation or a GPS receiver of one or more client computing devices, each client computing device corresponding to one of the one or more entities and in connection with a computational backend server residing in a healthcare data center;
a computational backend server configured to transform the electronic position information by appending one or more contextual metadata tags to the electronic position information to generate contextualized electronic position information, the one or more contextual metadata tags appended upon detecting that one or more electronic trigger conditions are satisfied;
a contextual profile management unit configured to generate or update one or more contextual profiles, each of the one or more contextual profiles corresponding to one of the one or more entities with the contextualized electronic position information, each of the one or more contextual profiles including at least a computationally approximated probabilistic risk level that is updated when the one or more contextual profiles are updated or generated;
wherein the computational backend server is further configured to aggregate the contextualized electronic position information with the contextual profiles to generate at least one electronic map structure storing, as location points, current locations of the one or more entities and associating, with each of the location points, the approximated probabilistic risk level for the corresponding individual, the map structure including one or more pathways; and
wherein the computational backend server is further configured to generate a visual or an audible notification on a computing interface linked to the computational backend server if the approximated probabilistic risk level of any individual is greater than a predefined threshold.

12. The system of claim 11, wherein the computational backend server is further configured to generate a visualization of the at least one electronic map structure; and to update, in real-time, the visualization as the one or more contextual profiles are updated or generated.

13. The system of claim 12, wherein the computational backend server is adapted for generating electronic task routing signals for a healthcare task scheduling system, the computational backend server is configured to receive signals representative of the location of a healthcare practitioner and a duration of availability and to superimpose a facility map and the at least one generated electronic map structure storing the current locations of the one or more entities as nodes,
wherein the approximated probabilistic risk level for each individual is re-weighted based at least on distance from the location of the healthcare practitioner, and the superimposing generates an initial practitioner location-contextualized electronic map structure.

14. The system of claim 13, further comprising a mapping visualization engine configured to generate an electronic map visualization of the initial practitioner location-contextualized electronic map structure where the re-weighted approximated probabilistic risk levels corresponding to each node are continuously monitored and a visual representation of the re-weighted approximated probabilistic risk level of each node is automatically resized or recolored based on the magnitude of the re-weighted approximated probabilistic risk level of the node.

15. The system of claim 13, wherein the computational backend server is configured to generate an electronic prioritized list, based on the initial practitioner location-contextualized electronic map structure, providing an ordered list of nodes ranked in accordance to the re-weighted approximated probabilistic risk level of the node.

16. The system of claim 15, wherein the computational backend server is configured to update the electronic prioritized list responsive to updated or generated contextual profiles.

17. The system of claim 13, the system further comprising:
a routing engine configured to, using the initial practitioner location-contextualized electronic map structure as an initial state, recursively generate candidate pathways starting from the location of the healthcare practitioner and visiting a subset or all of the nodes as available during the duration of availability, wherein each of the candidate pathways has a cumulative treatment score based on the approximated probabilistic risk level associated with each node visited and each node visited is stored as an electronic waypoint in an ordered list of electronic waypoints;
the routing engine further configured to select a single candidate pathway having a highest cumulative treatment score; and
wherein the routing engine is further configured to generate, in accordance with the selected candidate pathway and the ordered list of electronic waypoints, one or more routing instructions for transmission to a client computing device associated with the healthcare practitioner, the one or more routing instructions configured for automatically populating an electronic scheduler on the client computing device such that the healthcare practitioner is instructed to visit each of the electronic waypoints in the selected candidate pathway.

18. The system of claim 17, wherein the recursive generation of the candidate pathways further includes re-weighting each of the approximated probabilistic risk levels for neighboring nodes to a current node being traversed using the distance between the current node being traversed and the neighboring nodes.

19. The system of claim 17, further comprising an infection tracking engine configured to update the computationally approximated probabilistic risk level to include infection control information, the infection control information including at least a prevalence of transmission, one or more identified transmission vectors, and a severity of infection; and
wherein the infection tracking engine is configured to identify one or more estimated radii of transmission based on the prevalence of transmission, the one or more identified transmission vectors, and the severity of infection of one or more infected entities, and to increase the approximated probabilistic risk level for other entities that were in proximity with the one or more infected entities as determined by the estimated radii of transmission.

20. A non-transitory computer-readable medium having machine-readable instructions stored thereon, the instructions, which when executed, cause a processor to perform a computer-implemented method comprising:
receiving or continuously monitoring electronic position information associated with one or more entities within a healthcare facility during a duration of time, the electronic position information obtained through wireless signal triangulation or a GPS receiver of one or more client computing devices, each client computing device corresponding to one of the one or more entities and acting in concert with a computational backend server residing in a healthcare data center;
transforming, by the computational backend server, the electronic position information by appending one or more contextual metadata tags to the electronic position information to generate contextualized electronic position information, the one or more contextual metadata tags appended when one or more electronic trigger conditions are satisfied;
generating or updating one or more contextual profiles, each of the one or more contextual profiles corresponding to one of the one or more entities with the contextualized electronic position information, each of the one or more contextual profiles including at least a computationally approximated probabilistic risk level that is updated when the one or more contextual profiles are updated or generated;
aggregating, by the computational backend server, the contextualized electronic position information with profile information stored in the contextual profile to generate at least one electronic map structure storing, as location points, current locations of the one or more entities and associating, with each of the location points, the approximated probabilistic risk level for the corresponding individual; and
generating a visual or an audible notification on a computing interface linked to the computational backend server if the approximated probabilistic risk level of any individual is greater than a predefined threshold and the time coded contextual metadata tags.
